(19) United States
(12) Patent Application Publication
(10) Pub. No.: US 2007/0000445 A1
(43) Pub. Date: Jan. 4, 2007

(54) Automated pet feeding machine

(76) Inventors: Michel Blais, St-Jean-Sur-Richelieu (CA); Michel Champagne, St-Jean-Sur-Richelieu (CA)

Correspondence Address: INVENTARIUM, Suite 1607, 4050 Rosemont blvd, Montreal, QC, H1X 1M4, CA

(21) Appl. No.: 11/515,462

(22) Filed: Sep. 1, 2006

Related U.S. Application Data
(63) Continuation-in-part of application No. 10/435,418, filed on May 12, 2003, now abandoned.

(51) Int. Cl. A01K 5/02

(52) U.S. Cl. 119/56.1

(57) ABSTRACT

An automated pet feeding machine has a very simple system for measuring and distributing food quantities using the combination of an electric motor that moves a rod linearly and slidable panels to control the flow of food pellets into a bowl. The downward tilt motion of the food tray blocks any food from flowing out of the hopper during this step. A reverse rotation of the electric motor returns the food tray to its first position where the hopper's exit is liberated and a portion is once again poured into the food tray, ready for the next feed cycle.

This application is a continuation in part of application Ser. No. 10/435,418 filed May 12, 2003

### BACKGROUND OF THE INVENTION

1. Field of the Invention

This invention relates generally to automated machines and more particularly to machines that distribute pet food at preset intervals and in preset quantities.

2. Background

The prior art shows a number of pet food distribution machines, each automated to varying degrees of complexity. Generally, these machines have a large reservoir to contain food and a mechanism, generally in the form of a paddle wheel or in some cases a screw conveyor, that distributes a set quantity of food. A timer also allows for the food to be distributed at preset times. Variations between the different prior art can be found in the different ways by which food quantities are measured. For example, U.S. Pat. No. 5,303,672 by Morris, U.S. Pat. No. 4,079,699 by Longmore and U.S. Pat. No. 5,873,326 by Dave have a rotating wheel having sections that can be blocked to control the amount. This system is very prone to pellets jamming the system and there is only one quantity available. while U.S. Pat. No. 5,433,171 by Ewell uses weight as a way to measure quantities.

U.S. Pat. No. 6,273,027 by Watson uses a geared motor that opens an opening, this system is also prone to jamming.

U.S. Pat. No. 4,834,025 by Tum uses a tumbler and counterweight and requires manual adjustment as well as several trials and errors to get the right amount of food.

U.S. Pat. No. 4,363,291 by Harmsen uses a worm screw which requires two disctinct programming, one for the duration of rotation of the worm screw and one for the duration of the flow. There is no means to unblock potential jamming.

U.S. Pat. No. 5,193,722 by Groya has a plurality of compartments but they are used for increasing the flow not increasing the quantity.

There is U.S. Pat. No. 4,235,200 by Shay that, at first glance, appears similar to this instant application. Shay's invention provides a system for delivery of dry food in portioned amounts at regular intervals. It provides a system adaptable for feeding pets or livestock, for use in the home, in animal shelters, etc. . . . A food storage bin feeds dry food to a food delivery chamber which holds one serving of food. The food delivery chamber pivots on a pin from a loading position (loading mode) to a delivery position (delivery mode). The chamber is held in the loading position by a spring. Upon the activation of a solenoid, the food delivery chamber is pulled down, closing the passageway from the food storage bin to the food delivery chamber, and opening the passageway to a feeding tray. The food in the food delivery chamber then pours out to the feeding tray. The solenoid is activated by a timer so that feed material is delivered to the animals at regular intervals.

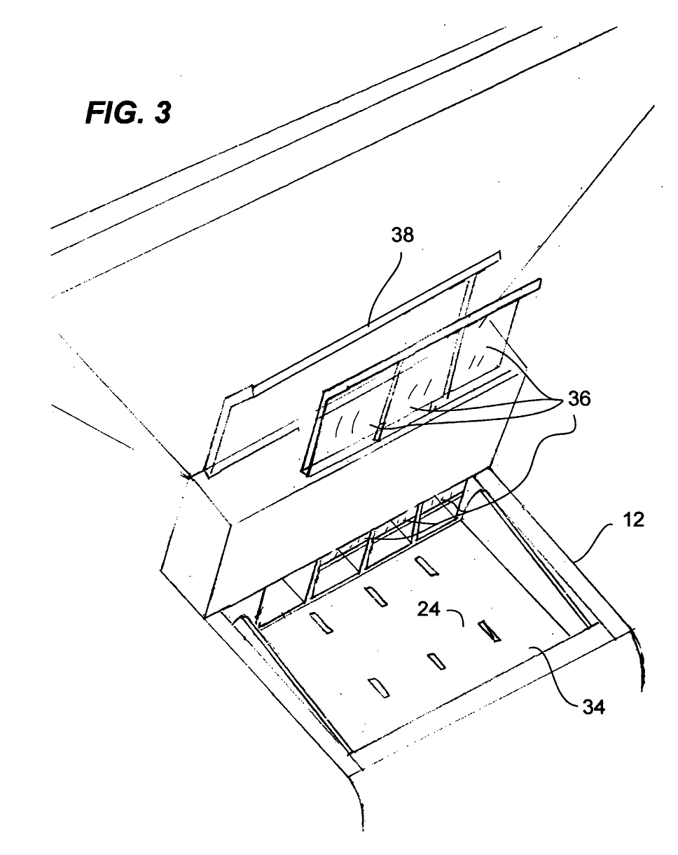

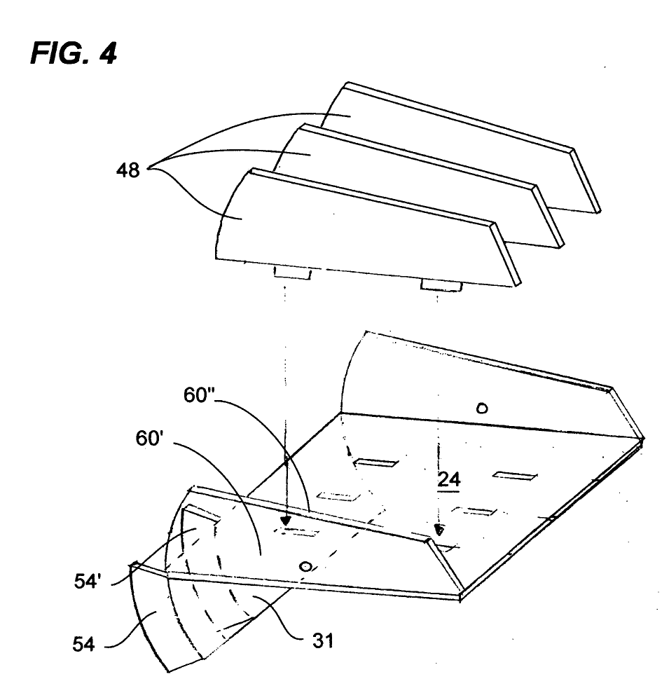

Similarities between the two inventions reside in a food delivery chamber that periodically pivots into the delivery mode upon being pulled upon by solenoid 20. The solenoid is affixed to housing 12 with its armature 60 connected by connector means 62 to mounting assembly 44. During the loading mode, the solenoid is not activated and its armature is pulled to an extended position, as can be seen in FIG. 3, by retention spring 18 which is attached to housing 12 and mounting assembly 44. When the solenoid is activated, the armature is drawn into a contracted position, as shown in FIG. 4, and in turn pulls the food delivery chamber into the delivery mode. When the solenoid is deactivated, armature 60 is released from its contracted position and is pulled back to its extended position when retention spring 18 pulls the food delivery chamber into the loading mode (see FIG. 3). The automatic animal feeder remains in the loading mode until solenoid 20 is activated again.

That is where similarities ends as there are several important differences between Shay and this instant invention dealing with how the quantities are adjusted, in Shay the food delivery chamber 16 is sized to hold a single portion of food for a particular animal. To accommodate the larger or smaller portions of food required by different animals, the food delivery chamber has to be made larger or smaller accordingly. Alternatively, solenoid 20 may be actived more frequently to deliver greater amounts of feed from a food delivery chamber of a fixed size. In other words, if the animal for which the automatic animal feeder is intended is changed, or if the portion size is to be changed for any reason whatsoever, the food delivery chamber with its mounting assembly needs to be changed. This is not a very practical feature.

Another difference resides in the discharge of food, Shay's system cannot accomodate a variety of pellet size without making a change to the opening 36 which is unchangeable. This lacking feature can cause jamming if the is not compatible with the size of the opening, for example, if the opening is 2.5 the width of a pellet and 2.5 pellets want to pass side by side, the likely hood of jamming is very high as 3 pellets want to pass where only 2 can fit. And, as already discussed, Shay can only change portion size by physically replacing food delivery chamber 16.

Another possible source of jamming resides in divider 58 pushing aside the feed which is between outlet 36 and receiving opening 38. This action can push the feed in hopper 14 and pack it in such a way that it is jammed in place and no longer falls by gravity alone. If the feed cannot be pushed, tehn tehre is jamming in the opening unless the solenoid is strong enough to crush the pellets and meanwhile, more pellets have time to fall into the food delivery chamber 16 which skews the desired quantity.

There is therefore a need for a practical, efficient, safe and inexpensive automated pet feeding machine.

### PRIOR ART CAPABILITY AND MOTIVATIONS, AS HELPING TO SHOW PATENTABILITY HERE

Even in hindsight consideration of the present invention to determine its inventive and novel nature, it is not only conceded but emphasized that the prior art had many details usable in this invention, but only if the prior art had had the guidance of the present invention, details of both capability and motivation.

That is, it is emphasized that the prior art had/or knew several particulars which individually and accumulatively show the non-obviousness of this combination invention. E.g.,

a) The nature of an invention as being a “novel combination”, in spite of existence of details separately, is especially significant here where the novelty is of the plurality of concepts, i.e., the use of a multiple tray system with two types of chute blockers, one for measuring quantities while the other provides customization according to pellet size used;

b) The matter of particular cost-factors, in a detailed form which provides for an affordably price point which makes the product more popular in the marketplace;

c) The cost-factors involved in the maintenance of wooden decks with frequent painting, staining or varnishing, replacing damaged or rotting planks, etc;

d) The prior art has always had sufficient skill to make this instant invention and more than ample skill to have achieved the present invention, but only if the concepts and their combinations had been conceived;

e) Substantially all of the operational characteristics and advantages of details of the present invention, when considered separately from one another and when considered separately from the present invention's details and accomplishment of the details, are within the skill of persons of various arts, but only when considered away from the integrated and novel combination of concepts which by their cooperative combination achieve this advantageous invention;

f) The details of the present invention, when considered solely from the standpoint of construction, are exceedingly simple, basically a plastic body with few simple moving parts, an electric motor and an electronics control PCB. The matter of simplicity of construction has long been recognized as indicative of inventive creativity;

g) Similarly, and a long-recognized indication of inventiveness of a novel combination, is the realistic principle that a person of ordinary skill in the art, as illustrated with respect to the claimed combination as differing in the stated respects from the prior art both as to construction and concept, is presumed to be one who thinks along the line of conventional wisdom in the art and is not one who undertakes to innovate; and

h) The predictable benefits from a novel automatic pet feeder having features of non blocking of food pellets, selection of food quantities and optimisation of food delivery according to pellet size would seem sufficiently high that others would have been working on this type of product, but only if the concepts which it presents had been conceived.

Accordingly, although the prior art has had capability and motivation, amply sufficient to presumably give incentive to the development a product and installation method according to the present invention, the fact remains that this invention awaited the creativity and inventive discovery of the present Inventor. In spite of ample motivation, the prior art did not suggest this invention.

### PRIOR ART AS PARTICULAR INSTANCES OF FAILURE TO PROVIDE THIS NOVEL PRODUCT AND INSTALLATION METHOD

In view of the general economic advantages, reliability advantages, feature rich advantages etc., of the present invention as an improved embodiment of the prior art, it may be difficult to realize that the prior art has not conceived of the combination purpose and achievement of the present invention, even though the need for automated devices to simplify human existence is a known requested commodity for people nowadays who have less and less time for leisure and many things on their mind which requires automated processes as means of freeing one's mind for other things. Surely the need for automated pet feeders has been known for decades and the technology to achieve such results has been known for years and that the various combination provided in this invention would have been desired and attempted long ago, but only if its factors and combination-nature had been obvious.

Other considerations, as herein mentioned, when realistically evaluated show the inventive nature of the present invention, a change in concept which the prior patent and other prior art did not achieve.

### SUMMARY OF THE PRIOR ART'S LACK OF SUGGESTIONS OF THE CONCEPTS OF THE INVENTION'S COMBINATION

And the existence of such prior art knowledge and related ideas embodying such various features is not only conceded, it is emphasized; for as to the novelty here of the combination, of the invention as considered as a whole, a contrast to the prior art helps also to remind of needed improvement, and the advantages and the inventive significance of the present concepts. Thus, as shown herein as a contrast to all the prior art, the inventive significance of the present concepts as a combination is emphasized, and the nature of the concepts and their results can perhaps be easier seen as an invention.

Although varieties of prior art are conceded, and ample motivation is shown, and full capability in the prior art is conceded, no prior art shows or suggests details of the overall combination of the present invention, as is the proper and accepted way of considering the inventiveness nature of the concepts.

That is, although the prior art may show an approach to the overall invention, it is determinatively significant that none of the prior art shows the novel and advantageous concepts in combination, which provides the merits of this invention, even though certain details are shown separately from this accomplishment as a combination.

And the prior art's lack of an invention of an economical, easy to program, adjust and control automated feeder which is reliable because of its anti blocking features which unblocks food in the hopper; prevents jamming during passing from the hopper to the trays and into the bowl; measures quantities precisely; allows for easy changing of quantities; and allows for a variety of dry pellet food to be used with the machine, all without risk of jamming, which are goals only approached by the prior art, must be recognized as being a long-felt need now fulfilled.

Accordingly, the various concepts and components are conceded and emphasized to have been widely known in the prior art as to various installations; nevertheless, the prior art not having had the particular combination of concepts and details as here presented and shown in novel combination different from the prior art and its suggestions, even only a fair amount of realistic humility, to avoid consideration of this invention improperly by hindsight, requires the concepts and achievements here to be realistically viewed as a novel combination, inventive in nature. And especially is this a realistic consideration when viewed from the position of a person of ordinary skill in this art at the time of this invention, and without trying to reconstruct this invention from the prior art without use of hindsight toward particulars not suggested by the prior art.

### FEATURES AND ADVANTAGES OF THE INVENTION

A first object of the present invention is to provide a practical pet feeding machine.

A second object of the present invention is to provide a pet feeding machine having anti blocking features.

A third object of the present invention is to provide a pet feeding machine that prevents jamming during passing from the hopper to the trays and into the bowl.

A fourth object of the present invention is to provide a pet feeding machine that measures quantities precisely.

A fifth object of the present invention is to provide a pet feeding machine that allows for easy changing of quantities.

A sixth object of the present invention is to provide a pet feeding machine that allows for a variety of dry pellet food to be used with the machine, all without risk of jamming.

A final object of the present invention is to provide an inexpensive pet feeding machine.

### SUMMARY OF THE INVENTION

In order to do so, the invention has a very simple system for measuring and distributing food quantities using the combination of an electric motor that moves a rod linearly and slidable panels to control the flow of food pellets into a bowl. The downward tilt motion of the food tray blocks any food from flowing out of the hopper during this step. A reverse rotation of the electric motor returns the food tray to its first position where the hopper's exit is liberated and a portion is once again poured into the food tray, ready for the next feed cycle.

Additionally, additional hopper modules can be purchased separately to increase the size of the hopper.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiments of the invention.

### BRIEF DESCRIPTION OF THE PREFERRED EMBODIMENT

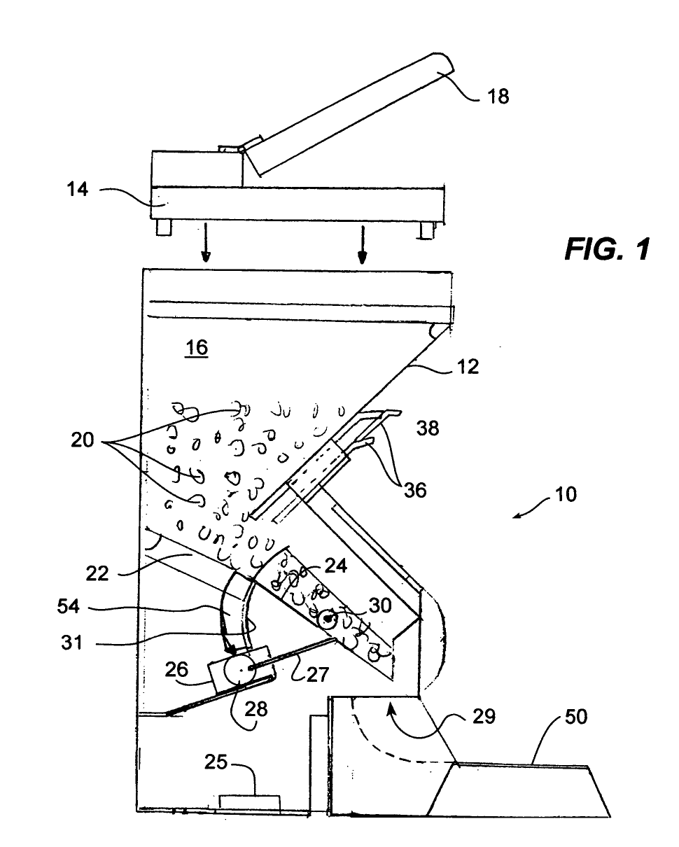

FIG. 1 Side elevation of the automated pet feeding machine set at the first mode.

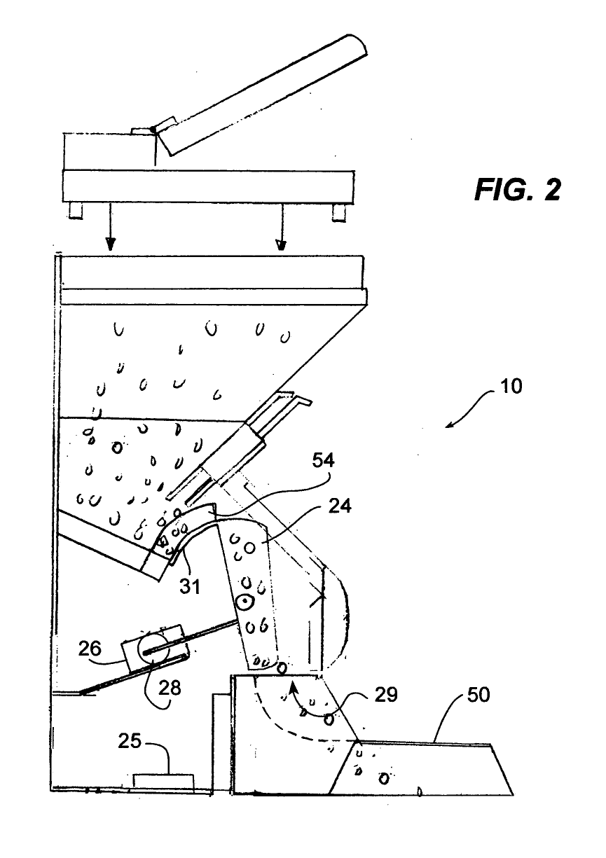

FIG. 2 Side elevation of the automated pet feeding machine set at the second mode.

FIG. 3 Orthogonal view of the food tray with its servings vanes.

FIG. 4 Orthogonal view of the food tray and its partitions.

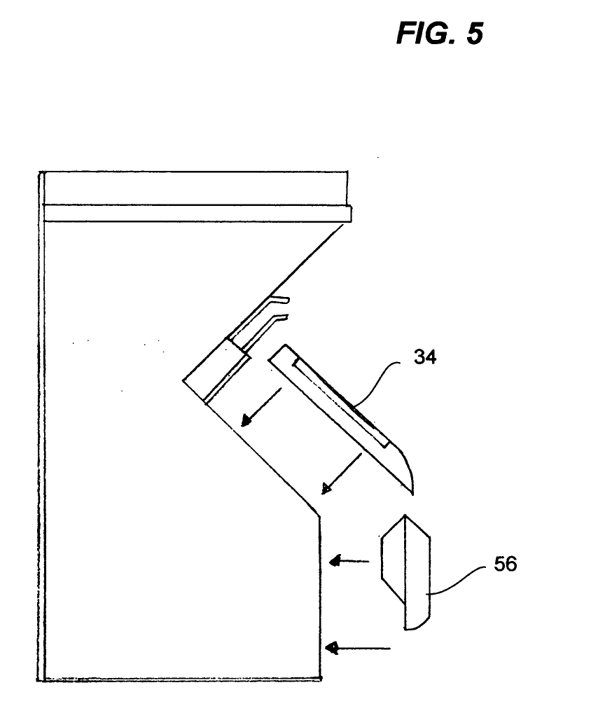

FIG. 5 Side elevation of the the automated pet feeding machine with its front panels taken out.

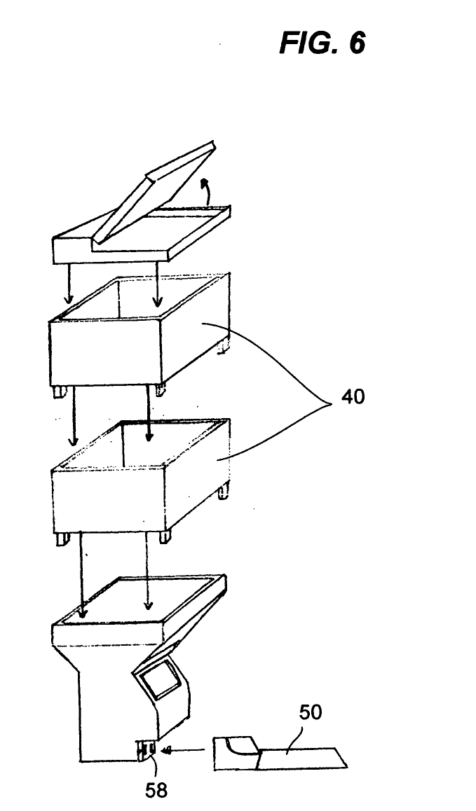

FIG. 6 Orthogonal view of the automated pet feeding machine with its additional hopper modules.

### DETAILED DESCRIPTION OF THE PREFERRED EMBODIMENT

FIG. 1 An automated pet feeding machine (10) has a housing (12), a removable lid assembly (14), a hopper (16), a chute (22) and a food tray (24). By lifting the lid (18) from the removable lid assembly system (14), a user can pour dry pet food (20) into the hopper (16). From there, the chute (22) allows some of the pet food (20) to spill into the food tray (24) where it will stay until a preprogrammed sequence on a PCB (25) activates a geared electric motor (26) which linearly moves a rod (27) by way of a wheel (28). The rod (27) tilts the food tray (24) around a rotational axis (30) downward from a first position into a second position where the pet food (20) is poured, via an exit aperture (29), into a pet feeding bowl (50). The use of motors transforming a rotational motion into a linear motion is well known and need not be further discussed here. A number of variations of such known means can be used as part of this invention without going beyond its scope.

FIG. 2 The downward tilt motion of the food tray (24) stops any pet food (20) from flowing out of the hopper (16) during this step by way of a chute blocker (31). Once the PCB (25) orders a reversal of the rotation of the electric motor (26), the food tray (24) returns to its first position where the chute (22) is once again liberated and a portion of pet food (20) is again poured into the food tray (24), ready for the next feed cycle.

FIG. 3 The housing (12) has a window (34) through which one can see the food tray (24). Entry of food is regulated by slidable vanes (36) which can be slid open one at a time with each vane (36) giving out one portion. There is preferably one less such vane (36) as there are compartments (60) since it is assumed that at least one compartment would always be used for a minimal amount of food (20) to be delivered.

Because of this very simple use of vanes (36), precise food quantities can be measured without resorting to electronic means of control which control electomechanical means such as worm screws and other such devices seen in the prior art. This increases reliability while reducing manufacturing costs. In a preferred embodiment, there are four compartments so that a user can easily divide portions in quarters. A main blocker (38) is used for controlling the flow according to pellet size. By sliding the main blocker (38), one can adjust the opening according to the size of the pet food (20) pellets so that the portions can flow out into the compartments (60) easily without jamming and it also helps in making a similar amount of pet food to fall into each compartment (60). The main blocker (38) also diverts the action of gravity that would otherwise have the pet food (20) apply pressure on the food tray (24) which would necessitate a more powerful electric motor (26).

FIG. 4 The food tray (24) is subdivided into a plurality of compartments (60) by partitions (48). The food tray (24) also has a chute blocker (31) which stops the pet food (20) from escaping the from the hopper (16) while the food tray (24) moves into its second position. There are two fins (54, 54′) extending perpendicularly from the rear of the chute blocker (31) that are positioned and configured so as to eliminate all possible jamming of food. The first fin (54) is positioned against the housing (12) and in line with the side of the food tray (24) while the second fin (54′) is in line with the partition (48) which separates the first compartment (60′) from the second compartment (60″). When the food tray (24) moves from the first to the second position, the fins (54, 54′) push into the food (20) and actually create an area where the food is less packed which ultimately prevents jamming of the food (20) so that it can easily flow into the food tray (24) afterwards.

FIG. 5 Access to the food tray (24) is made easy through a removable window (34) as well as a removable bottom panel (56) which gives access to the electric motor (26) as well as the PCB (28) for easy servicing and cleaning since, over time, fine food powder can find its way there.

FIG. 6 Additional hopper modules (40) can be purchased separately to increase the capacity for food (20) storage. The bowl (50) is releasably attached by releasably attachable means (58) to the rest of the pet feeding machine (10) so that the food (20) can spill into it properly and so that pets can't displace it while being sufficiently releasable for cleaning purposes.

The PCB (28) controls the following mode of operation: Upon first use or when reprogramming, time of day is adjusted followed by a selection of feeding time. A time is selected by the user for at least one but preferably more feeding times during a full 24 hour day. The user can also override any preset feeding time by pressing a button that will immediately deliver a portion of pet food (20). There are of course more features that can be programmed as the cost of electronic components allow to upgrade features while keeping costs constant. These features are also anticipated by other automated pet feeders of teh prior art but the reliance of simple yet efficient mechnical systems in theis instant invention allows for a very simple and inexpensive PCB to complement the functionality of this device.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. An automated pet feeding machine comprising:
a housing, a removable lid assembly, a hopper, a chute a food tray and a bowl;
an electric motor to linearly actuate a rod that tilts said food tray around a rotational axis from a first position into a second position and back;
a chute blocker to stop food from escaping said hopper while said food tray is in its second position;
a plurality of slidable vanes to regulate quantitiy of food;
a main blocker slidably adjustable according to the size of said food;
two fins extending perpendicularly from said chute blocker, positioned and configured so as to eliminate possible jamming of food.

2. An automated pet feeding machine as in claim 1 wherein:
said food tray being subdivided into a plurality of compartments by partitions.

3. An automated pet feeding machine as in claim 1 wherein:
said fins positioned one against the housing and in line with the side of said food tray while a second fin is in line with the partition which separates the first compartment from the second compartment.

4. An automated pet feeding machine as in claim 1 wherein:
additional hopper modules provided to increase the capacity for food storage.

5. An automated pet feeding machine as in claim 1 wherein:
said bowl is releasably attached to the rest of the pet feeding machine.

6. An automated pet feeding machine comprising:
a housing, a removable lid assembly, a hopper, a chute a food tray and a bowl;
an electric motor to linearly actuate a rod that tilts said food tray around a rotational axis from a first position into a second position and back;
a chute blocker to stop food from escaping said hopper while said food tray is in its second position;
a plurality of slidable vanes to regulate entry of food;
a main blocker slidably adjustable according to the size of the food;
two fins extending perpendicularly from said chute blocker, positioned and configured so as to eliminate possible jamming of food;
said food tray being subdivided into a plurality of compartments by partitions;
said fins positioned one against the housing and in line with the side of said food tray while a second fin is in line with the partition which separates the first compartment from the second compartment;
additional hopper modules provided to increase the capacity for food storage;
said bowl releasably attached to the rest of the pet feeding machine.
